(19) United States
(12) Patent Application Publication
(10) Pub. No.: US 2007/0145854 A1
(43) Pub. Date: Jun. 28, 2007

(54) Motor

(76) Inventors: Yuji Enomoto, Hitachi (JP); Motoya Ito, Hitachinaka (JP); Ryoso Masaki, Hitachi (JP); Shoji Ohiwa, Saitama (JP); Chio Ishihara, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/646,403

(22) Filed: Dec. 28, 2006

(30) Foreign Application Priority Data
Dec. 28, 2005 (JP) 2005-376854

(51) Int. Cl. H02K 37/14; H02K 3/04; H02K 1/12

(52) U.S. Cl. 310/257; 310/49 R; 310/208

(57) ABSTRACT

A claw-pole motor according to the present invention has the maximum occupancy ratio of a wound wire by using a rectangular electric wire for the annular coil of a claw-pole-type motor, winding the rectangular electric wire into an almost analogous shape with the cross section of a wound-wire space and setting the rectangular electric wire. Moreover, a lead-out portion is formed by keeping the shape of a lead-out portion as a rectangular wire, the terminal portion of the lead-out portion is deformed into a predetermined connector shape by appropriate processing method and a insulating coating is removed. Thereby, it is possible to greatly decrease man-hours of a terminal connecting portion.

### BACKGROUND OF THE INVENTION

(1) Field of the Invention

The present invention relates to the structure of a claw-pole-type motor used for industries, home electric appliances, and automobiles.

(2) Description of Related Art

A motor is used as driving equipment for converting electric energy into mechanical output in industries, home electric appliances, and automobile. A claw-pole-type motor is used in equipment such as for office automation and an automobile, for its inexpensive structure, simple driving circuit, and the like. For example, there is a motor having the configuration disclosed in JP-A-2005-20981 (hereafter referred to as Patent Document 1).

In this type of the claw-pole-type motor, as shown in Patent Document 1, the material of a stator core generally uses rolled steel such as JIS (Japan Industrial Standard) SPCC. A typical structure has a claw magnetic pole portion formed by bending a part of the steel plate and a cylindrically wound coil interposed between the cores.

### BRIEF SUMMARY OF THE INVENTION

In the case of the motor disclosed in Patent Document 1, a cylindrically wound coil is made of an enamel wire whose cross section is circular and is wound on a coil bobbin. In this case, the occupancy ratio of the coil is 50% or less due to the gap between round wires or irregularities in the winding. Further, if the shape of the space for the wound wire is suitable for winding the wire, for example, an almost rectangular, such shape will not reduce the occupancy ratio: however, if the space has a complex shape, a dead space is created and further reduces the occupancy ratio.

Furthermore, in the case of a motor for drive with a low voltage, the diameter of a conductor increases and the number of winding decreases. In which case, depending on the diameter of the conductor and the space for the wound wire, the placement may be difficult and the occupancy ratio may be further reduced.

It is an object of the present invention to provide a claw-pole-type motor with a high occupancy ratio of wound wire.

A feature of the present invention lies in the fact that a motor is provided with a first teeth core and second teeth core each having a plurality of claw-shaped teeth magnetic poles on the circumference of the motor, a stator having a ring-shaped conductor interposed between the first teeth core and second teeth core, and a rotor disposed inside the stator, in which the cross section of the conductor is almost square or rectangle. Other features of the present invention will be described in Detailed description of the invention.

According to the present invention, it is possible to provide a claw-pole-type motor having a large occupancy ratio of wound wire. In more details, the present invention improves the occupancy ratio of a wound wire even when a wound-wire space is not suitable shape for easily containing a wire such as an almost rectangular shape or even in the case of a motor having a low driving voltage, large diameter of a conductor, and a small number of winding times.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWING

FIG. 1 is a perspective view showing the phase separation structure of the stator core of the motor of an embodiment of the present invention;

FIG. 2A is a perspective view showing a part of an example of the claw-pole-type motor of a comparative example by a sectional view;

FIG. 2B shows a method for shaping a stator core of a comparative example;

FIG. 3A is a sectional view showing a general arrangement of wound wires of the stator coil of a claw-pole-type motor;

FIG. 3B is a sectional view showing an arrangement of wound wires of a stator coil when the specification of a motor is for a low-voltage;

FIG. 3C is a sectional view showing an arrangement of wound wires of a stator coil by a rectangular wire;

FIG. 3D is a perspective view showing a terminal wire at the winding start side of an arrangement of wound wires in FIG. 3C;

FIG. 3E is a sectional view showing a structure having a wire in FIG. 3D to be interposed between claw teeth cores;

FIG. 3F is a sectional view showing a wire-wound arrangement so that the winding start and winding end wires of a coil are brought to the outside diameter side;

FIG. 3G is a perspective view showing an arrangement of one-layer edge-wise windings of a rectangular wire;

FIG. 3H is a sectional view of the arrangement shown in FIG. 3G;

FIG. 4A shows a sectional view of an example of a stator coil of a claw-pole-type motor using powder core as a core;

FIG. 4B shows a sectional view of an example using an edge-wise winding of the stator coil of a claw-pole-type motor using powder core as a core;

FIG. 5 shows a method for forming a wound wire in which both terminal lead-out portions of a coil is arranged at the outer periphery of the coil;

FIG. 6 shows a method for manufacturing coils having different conductor sectional areas for each layer of a coil;

FIG. 7 shows a coil shape for joining a lead wire, in which a coil wound by a rectangular conductor has a round or other shape cross section in lead-out portions of both ends;

FIG. 8A is a perspective view for describing the shape of a lead-out portion when directly taking out both ends of a coil wound by a rectangular conductor;

FIG. 8B is a perspective view for describing the shape of a lead-out portion when joining the lead wire shown in FIG. 7 by means of welding;

FIG. 8C is a perspective view showing a state in which the terminal portion of the lead-out portion shown in FIG. 8A is formed into a connector shape to connect to the corresponding lead wire with a connector attached thereto;

FIG. 9A is a perspective view showing a state in which a round cross-section conductor is annularly wound;

FIG. 9B is an illustration for describing a concept for improving the occupancy ratio by compacting the coil shown in FIG. 9A after wire-winding it, which is a sectional view showing a state in which the cross section is compacted by using a die;

FIG. 9C is a perspective view of the coil shown in FIG. 9B; and

FIG. 10 shows a method for cylindrically wire-winding a rectangular electric wire.

### DESCRIPTION OF REFERENCE NUMERALS

1 . . . Upper claw teeth core, 2 . . . Lower claw teeth core, 3 . . . Coil, 4 . . . Insulator (Insulating bobbin), 5 . . . Conductor, 6 . . . Wire storage ring, 7 . . . Wire wound flyer, 8 . . . Spool, 9 . . . Rolling roller, 10 . . . Drawing wire (Lead), 11 . . . Connector

### DETAILED DESCRIPTION OF THE INVENTION

The present invention constitutes a motor stator block for one phase by interposing a coil between a lower claw teeth core and an upper claw teeth core. In this constitution, to increase the occupancy ratio of the coil, the coil wounded by a conductor having an almost rectangular cross section is mounted.

### EMBODIMENT 1

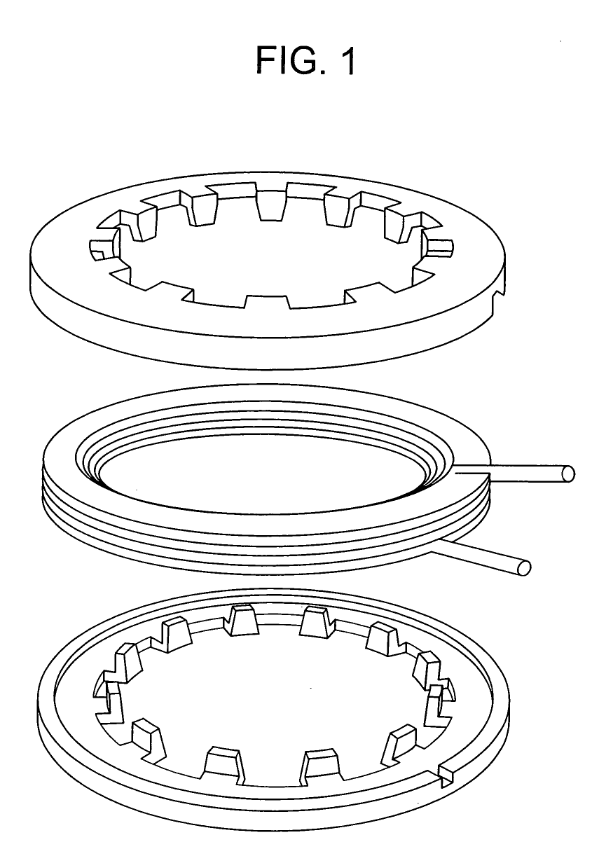

FIG. 1 shows a configuration of a claw-pole-type motor for one phase according to the present invention. A motor stator block for one phase is constituted by interposing a coil between a lower claw teeth core 1 and upper claw teeth core. In order to increase the occupancy ratio of the coil, the coil wound by a conductor having an almost-rectangular cross section is mounted.

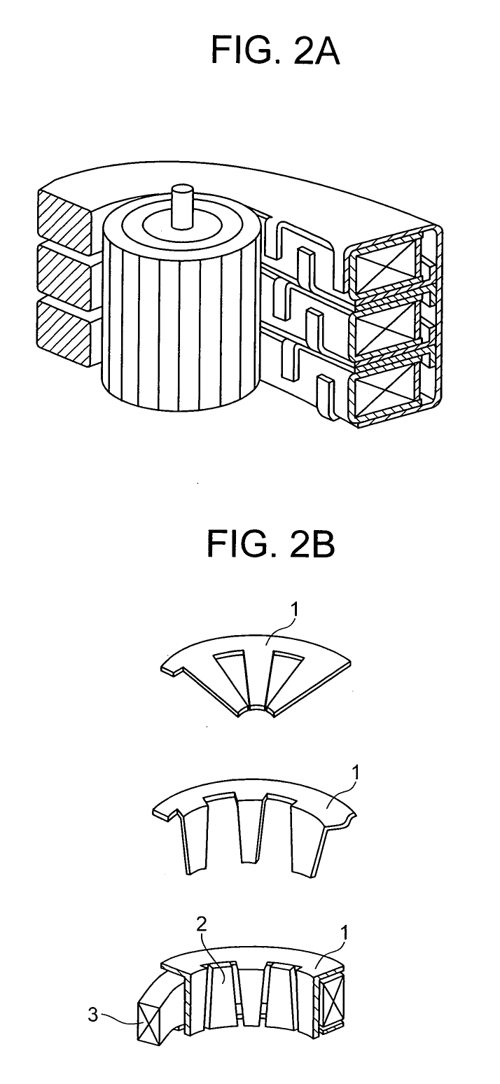

FIGS. 2A and 2B show perspective views of the structure of a claw-pole-type motor (some of them are sectional views) as a comparative example. The motor is normally constituted of a core having two stages in the axial direction as shown in FIG. 2A as a two-phase stepping motor. The material of the stator core for each stage is made of a rolled steel plate such as JIS SPCC. As shown in FIG. 2B, after a shape of the core is formed by press punching, a claw magnetic pole portion is constituted by bending a certain portion to interpose a cylindrically wound coil between the cores of the claw magnetic pole portion. However, this structure has a problem that the iron loss generated in the core increases because JIS SPCC, which is poor in magnetic characteristics, is used. Moreover, because the JIS SPCC is bent during manufacturing process, a residual stress is generated at the portion where the core is bent and the magnetic characteristic is further deteriorated due to a strain. Because the bent portion is a portion to which the magnetic flux is concentrated, a large iron loss is generated and the motor has a low efficiency. The output and efficiency of the motor may be improved by reducing a copper loss. It is possible to decrease a coil resistance value and decrease the copper loss of the motor by placing to the greatest maximum number of conductors in the placement space for the coil, which is shown in FIG. 1. The wound wire of Patent Document 1 is flat wise and a method for forming the lead-out portion of the winding start position of wound wire is difficult. The claw-pole-type motor of this embodiment has an advantage that the motor using an annulus coil can be easily manufactured because R (radius) of wound wire is uniform (constant). In the case of a slot motor, it is difficult to make the slot almost rectangular cross section and to improve an occupancy ratio even if a rectangular wire is used. To the contrary, in the case of a claw-pole-type motor, an occupancy ratio can be improved because a cross section with which a coil is placed becomes almost rectangular.

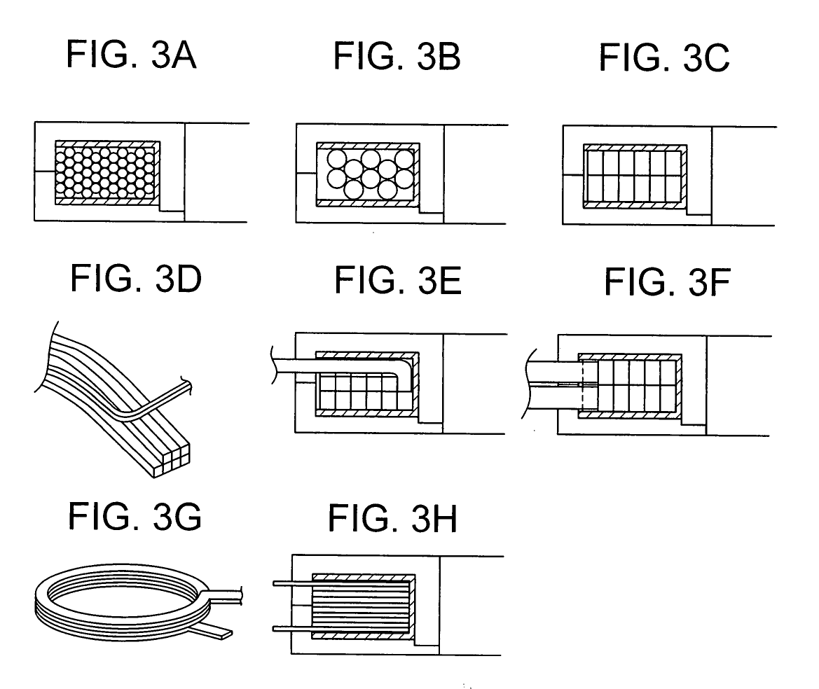

FIGS. 3A to 3H respectively show an example for placing a wound wire in a wound-wire space. An arrangement example for a core obtained by bending an iron plate is FIG. 3A. This arrangement generally includes many thin wires. The occupancy ratio in this case normally becomes 50% or less by a gap due to random winding. Then, a case when the specification of a motor is for a low-voltage is shown in FIG. 3B. If the diameter of a conductor increases, it is impossible to place conductors having the same sectional area as that of thin wire in this wound-wire space and the occupancy ratio is further lowered as shown in FIG. 3B. To solve this problem, it can be considered to use a rectangular wound wire as a coil which can be set within the wound-wire space even if the sectional area of one conductor increases. However, simply placing a rectangular wire causes the wire at the winding start side of the terminal wire to be seen as shown in FIG. 3D, although it seems to be filled with the wound wire when viewed in the cross section as shown in FIG. 3C, and a winding start wire rides on the outside of the almost rectangular cross section. In fact, when considering a structure interposed between claw teeth cores as shown in FIG. 3E, the gap for the structure is required and an occupancy ratio cannot be increased. Therefore, as shown in FIG. 3F, by placing a wire-wound coil so that winding-start and winding-end wires of the coil are brought to the outside, it is possible to improve the occupancy ratio. It is also possible to bring winding-start and winding-end wires on the same cross section as that of the coil by using an one-layer edge-wise winding of the rectangular electric wire as shown in FIG. 3G. Therefore, as shown in FIG. 3H, it is possible to improve the wound-wire occupancy ratio. The edge-wise winding means a rectangular wire so that the cross-sectional longitudinal direction of the wire is equal to a diameter direction of the winding.

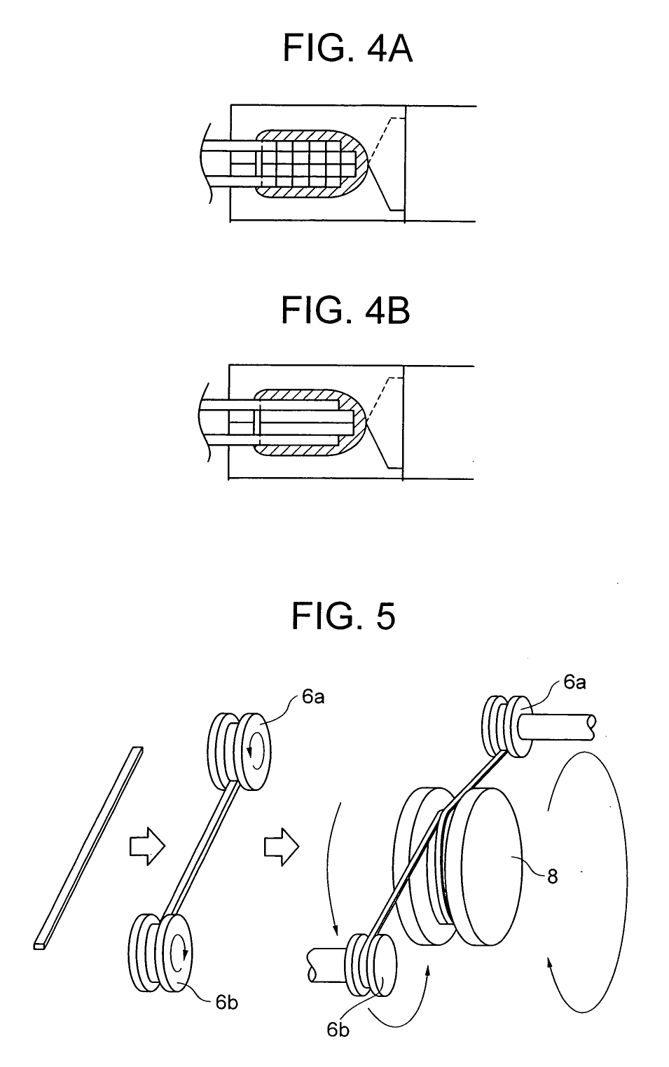

In order to further improve the efficiency of a claw-pole-type motor, it is necessary to decrease the core loss. In this case, by moderating the saturation of the folded portion of a core or using a material having a low core loss, it is possible to decrease the core loss. To obtain a material having a low core loss, a method for constituting a core by a powder core can be employed. This material can be three-dimensionally shaped by using a mold forming. In this case, compression load at the stage of a compact is left as a residual stress. However, because heat treatment is performed thereafter, it is possible to remove the residual stress of the whole three-dimensional core and realize a high magnetic-flux density and low core loss. Therefore, it is possible to constitute a high-efficiency motor having a large output density by increasing the sectional area of a claw portion so that even to a high magnetic-flux density can be covered or increasing the sectional area of a root portion to moderate saturation. In the case where an output density or realizing high efficiency is to be improved as above-mentioned, it is preferable to decrease the resistance of a wound wire and copper loss in order to decrease the loss of a motor. To decrease the copper loss, it is necessary to increase the occupancy ratio of a coil to be disposed inside a wound-wire space as described above. FIGS. 4A and 4B show a coil arrangement capable of improving the occupancy ratio when constituting the core of a claw-pole-type motor by powder core. In the case of the powder core, the sectional area of the root portion of a claw pole is designed on a large scale. Therefore, a cross-sectional shape of the coil placement space is not rectangular or square and therefore is not suitable to easily set a wound wire. Therefore, to arrange wound wires at a high density, coil arrangement should be adapted to the placement space. Also arranging a rectangular wire, it is possible to increase the occupancy ratio by the number of stages at the claw pole side is 2 and the whole becomes four stages as shown in FIG. 4A and terminal lines of the coil are arranged at the outside of the coil as described above. Moreover, in the case of using an edge-wise winding, it is possible to realize a high-occupancy-ratio coil having a wound-wire cross section almost analogous to a wound-wire mounting space as shown FIG. 4B by forming a sectional shape necessary for each cross section through rolling and performing wire-winding.

FIG. 5 shows a method for manufacturing a wound wire in which both terminal lead-out portions are arranged at the outer periphery of a coil by the rectangular wire shown in FIG. 3F and FIG. 4A. First, the rectangular wire is cut by a predetermined length necessary for the final coil. The rectangular wire is wound on wire-storage rings 6a and 6b from the both ends of the predetermined-length rectangular wire. Finally, delivering the wire from both wound wire-storage rings, while rotating the rings in the opposite direction on a winding frame 8. Thereby, it is possible to manufacture a coil in which both ends of the wound wire are arranged to the outside diameter portion of the coil.

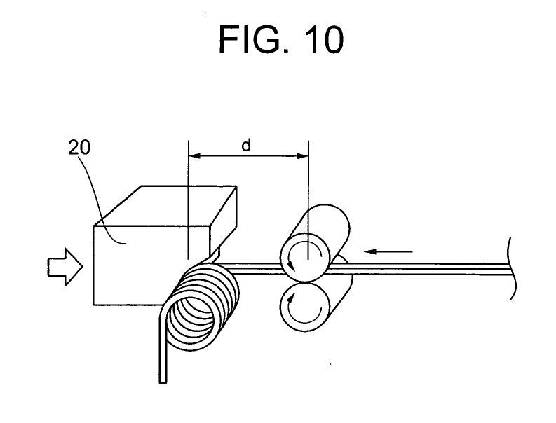

FIG. 10 shows a method for cylindrically winding a rectangular wire. To manufacture a coil spring from a stainless steel or piano wire, a method for winding a delivered wire by pressing it against a shaping piece is generally used. By using this method, it is possible to obtain the cylindrical high-density coil of a claw-pole-type motor according to the present invention. This method can perform wire winding for deciding the diameter of a coil to be manufactured by changing the distance d from the roller of the shaping piece 20 shown in FIG. 10 and for deciding the pitch of a coil to be manufactured by changing the speed of wire delivered from a roller. This method is suitable for a method for wire-winding one layer at a high density and is effective when the coil placement space of a claw-pole-type motor is almost rectangular.

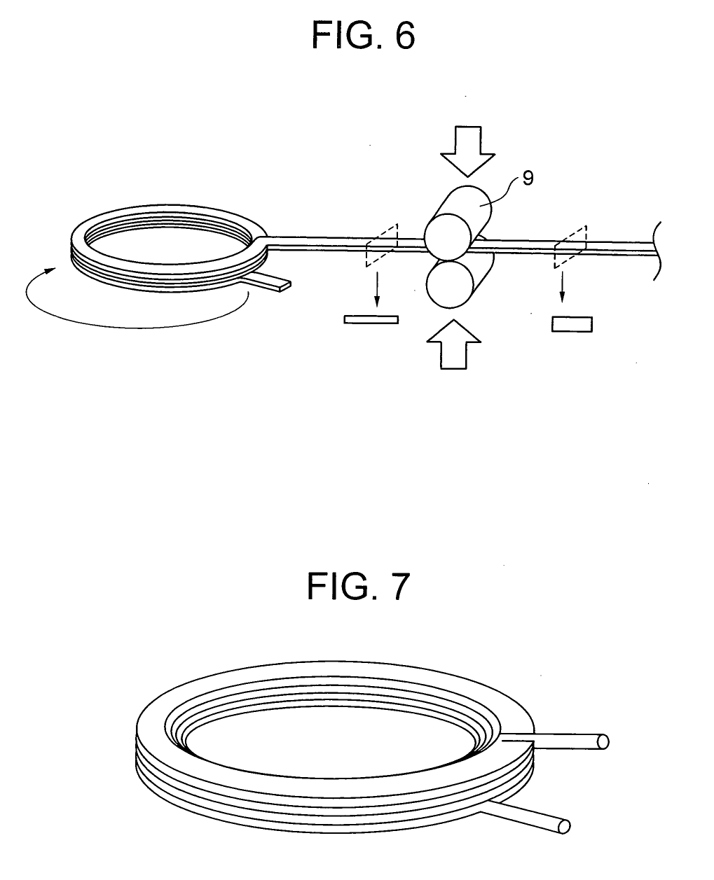

FIG. 6 shows a method for obtaining coil whose cross sections differs every layer as shown in FIG. 4B. A step of performing rolling by a reduction roller 9 is set between a portion for delivering a wire rod and a step of performing wire winding like a coil and wire winding is performed after forming a shape having a thickness smaller than and a width larger than those of the original wire rod. Thereby, it is possible to manufacture coil having sectional areas different for each layer. It is possible to realize a coil having a high occupancy ratio as described above by these methods.

FIG. 7 shows an example for using a round wire as a lead wire for the terminal wire portion of a coil on which a rectangular wire is wound. In the case of directly taking out the rectangular wire, it is requested to decrease the bend radius R. To the contrary, according to the example shown in FIG. 7, it is possible to compactly set a lead wire at a right angle by connecting a lead electric wire serving as a lead wire to a cylindrically-wound coil by using the method of welding, caulking, or soldering.

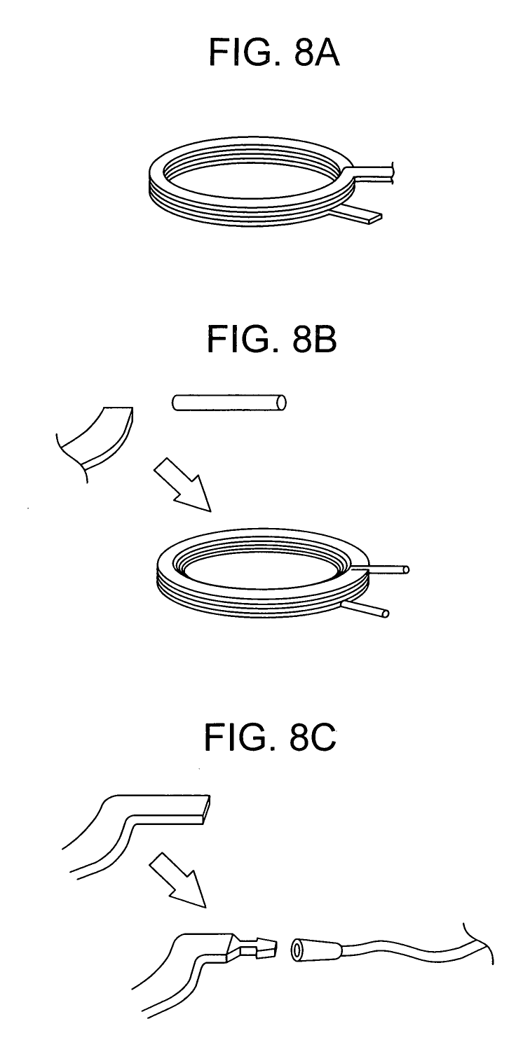

FIGS. 8A to 8C show three examples of lead wires. FIG. 8A shows a case of directly taking out a rectangular wire. FIG. 8B shows a shape formed by joining the lead wire (round wire) such as shown in FIG. 7 by welding. FIG. 8C shows an example of directly shaping a lead portion of the rectangular wire, forming the terminal portion to a prescribed connector shape by press punching, cutting, fusing, or discharging and removing a insulating coating on the wire of the connector portion. By forming the worked lead wire into a shape which can be directly connected with the other party having a lead wire including a connector as shown in FIG. 8C, it is possible to omit a lead-wire connecting step.

### EMBODIMENT 2

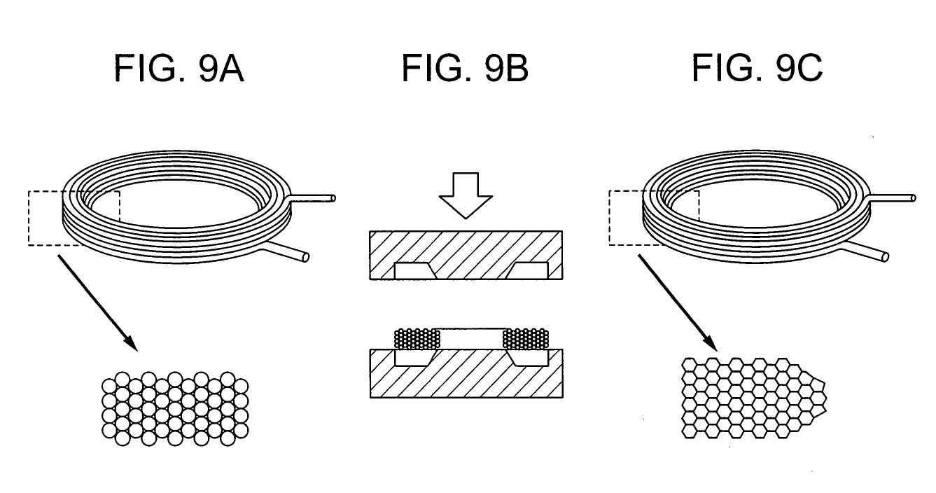

Then, a method for improving the occupancy ratio of a coil by another method is described below. A normal enameled conductor having a round cross section is circularly core-wound and formed into regular winding as shown in FIG. 9A. The cross section of the wire-wound coil is compacted by using the mold shown in FIG. 9B. In this instance, because a wire rod is deformed in accordance with the die shape, the cross section of the coil deforms into the die cross-section shape as shown in FIG. 9C. It is found that an insulating coating is sustainable to the extent of certain elongation. It is possible to mount a coil on a coil placement space at a high occupancy ratio in a claw-pole-type motor constituted by powder core.

According to the claw-pole-type motor of the above embodiment, it is possible to greatly improve the wound-wire occupancy ratio and thereby decrease a wound-wire resistance, and decrease the copper loss of a motor. Therefore, it is possible to provide a motor with high output and high efficiency. Moreover, because the contact area between conductors can be increased so that the thermal conductivity of the heat generated by a coil is improved, thereby an advantage that heat dissipation is easily performed can be obtained.

It should be further understood by those skilled in the art that although the foregoing description has been made on embodiments of the invention, the invention is not limited thereto and various changes and modifications may be made without departing from the spirit of the invention and the scope of the appended claims.

1. A motor comprising a stator having a first teeth core and second teeth core each having a plurality of claw-type teeth magnetic poles on the circumference thereof, a ring-shaped stator coil of a wound conductor interposed between the first teeth core and the second teeth core and a rotor disposed inside the stator, wherein the sectional shape of the conductor is almost square or almost rectangular.

2. The motor according to claim 1, wherein both ends of the terminal portion of the stator coil are placed outside diameter side of the coil.

3. The motor according to claim 1, wherein the stator coil is placed so that the number of layers of the conductor equals to an even number and has a structure in which the stator coil is wire-wound from the inside central portion of the inner periphery of the conductor by using the central portion of the conductor as a winding start position.

4. The motor according to claim 1, wherein the stator coil comprises a conductor having an almost rectangular cross section and edge-wise-wound so that the longitudinal direction of the rectangular cross section is overlapped.

5. The motor according to claim 1, wherein the first teeth core and the second teeth core comprises powder core.

6. The motor according to claim 1, wherein the sectional shape of the conductor is almost rectangular and every number of windings obtained by edge-wise-winding the conductor differs every number of windings.

7. A motor comprising a stator having a first teeth core and second teeth core each having a plurality of claw-type teeth magnetic poles on the circumference thereof, and a ring shaped coil of a wound conductor interposed between the first teeth core and the second teeth core and a rotor disposed inside the stator, wherein the sectional shape of the conductor is almost rectangular and the terminal portion of the coil obtained by edge-wise-winding the conductor is worked into a shape fitted with a connector to be connected with the terminal portion by press punching, machining, electric discharge machining, or laser beam machining.

8. The motor according to claim 7, wherein the first teeth core and the second teeth core comprises powder core.

9. A motor comprising a stator having a first teeth core and second teeth core each having a plurality of claw-type teeth magnetic poles on the circumference thereof, and a ring shaped coil of a wound conductor interposed between the first teeth core and the second teeth core is wound and a rotor disposed inside the stator, wherein the sectional shape of the conductor is almost rectangular, the conductor is wound by an edge-wise winding wire, and a conductor having another sectional shape on the terminal portion of the coil is joined through welding, bonding, pressure welding, soldering, or brazing.

10. The motor according to claim 9, wherein the first teeth core and the second teeth core comprising powder core.
